(19) United States
(12) Patent Application Publication
(10) Pub. No.: US 2002/0167989 A1
(43) Pub. Date: Nov. 14, 2002

(54) Coffee cup with temperature indication

(76) Inventor: Michael L. Russo, Wilmington, MA (US)

Correspondence Address: COHEN SMITH & WHITE, 57 BEDFORD STREET, SUITE 103, LEXINGTON, MA, 02420, US

(21) Appl. No.: 09/681,631

(22) Filed: May 14, 2001

(51) Int. Cl. G01K 1/14; G01K 13/00; G01K 11/12

(52) U.S. Cl. 374/141; 374/162; 374/157; 116/216

(57) ABSTRACT

A coffee cup contains a temperature indicating device which informs the user as to whether the liquid within is too hot to comfortably drink, too cold, or otherwise. The temperature-indicating device is thermochromic, changing color as a function of temperature. In one embodiment, three segments are printed onto the cup lid using thermochromic ink. One of these segments changes color to indicate the liquid is cool, another when the liquid is warm, and a third when hot. In another embodiment, the cup itself is printed with the thermochromic ink, and changes color to indicate the temperature of the liquid. In yet another embodiment the material of which the cup and lid are made is itself thermochromic.

### BACKGROUND OF INVENTION

1. Field of the Invention

The present invention relates to cups, such as coffee cups, which include temperature displays attached, and more specifically, cups which contain thermochromic material attached to the cup body or lid.

2. Description Relative to the Prior Art

It is clearly desirable to have a coffee cup which displays the temperature of the liquid within. This has not been done to date because of the expense of doing so.

A notorious lawsuit, brought several years ago against McDonald″s restaurant franchise by a woman scalded by hot coffee, resulted in a six-figure recovery (which was later reduced). Nevertheless, it would be clearly advantageous to sellers and consumers of takeout coffee to know if the temperature of the coffee in the cup.

The present invention provides a very cheap, and highly visible means to display the temperature of the coffee within the cup. An inexpensive thermochromic material is affixed to the cup, typically at the lid, which changes color depending upon temperature. The material is provided in strips or segments of thermochromic paper, or by printing directly on the cup using thermochromic ink. The temperature is indicated in ranges, rather than in absolute temperatures, so that the user may know, by viewing the thermochromic material, that the coffee is either too cold, too hot, or “just right.

Thermochromic materials have been long known, but only recently have inexpensive, simple thermochromic materials, including thermochromic ink, been widely available. U.S. Pat. No. 4,028,118, describes a number of techniques for producing such materials. Materials are now available which change color when temperature is between selected ranges, or when the color is greater or less than a predetermined temperature.

Additional advantages of the invention include reminding the user that the coffee is getting cold, as well as when it is too hot. It is also clear that the invention can be used with cups of other liquids besides coffee, such as tea, soup, etc.

### SUMMARY OF INVENTION

A general object of the current invention is to provide a device or means to display the temperature of a liquid contained within a drinking cup.

In accordance with one aspect of the invention, a cup intended for containing liquids has a lid having a temperature-indicating device attached.

In accordance with a second aspect of the invention, the temperature-indicating device is thermochromic ink.

In accordance with a third aspect of the invention, the temperature indicating device contains two or more segments, each of which becomes visible within a different temperature range.

In accordance with a fourth aspect of the invention, the temperature indicating device has two or more segments, each of which changes color within a different temperature range.

In accordance with a fifth aspect of the invention, the temperature indicating device is affixed to the cup itself.

### BRIEF DESCRIPTION OF DRAWINGS

These, and further features of the invention, may be better understood with reference to the accompanying specification and drawings depicting the preferred embodiment, in which:

FIG. 1 depicts a perspective view of the coffee cup, with the temperature indicating segments attached to the lid.

### DETAILED DESCRIPTION

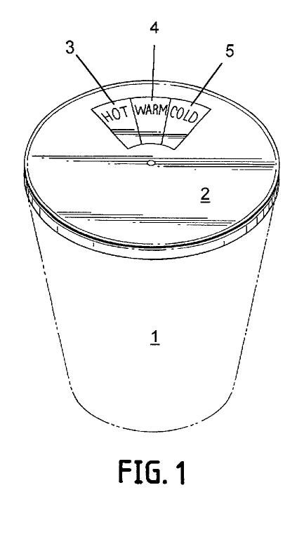

The device may be understood by referring to FIG. 1, which depicts a coffee cup 1 having a lid 2, upon which three segments 3, 4, and 5 are affixed. Each of these segments is thermochromic material, changing color as a function of temperature. The preferred material is a thermochromic ink, which is extremely inexpensive and can be printed directly onto the cup or lid. In alternative embodiments, the material may be thermochromic paper, easily affixed by various types of adhesives.

Segment 3 represents hot, and becomes visible when the temperature of the coffee becomes excessive, that is, too hot for the average person to comfortably drink.

Segment 4 represents warm, and becomes visible when the temperature of the coffee is within a range corresponding to a comfortable temperature to drink, for the average person. Segment 5 becomes visible when the temperature of the coffee drops below the temperature which activates the WARM segment.

In an alternative embodiment, only two segments may be used, one for hot, one for cold. The segments may strips of color, or they may be words, such as HOT and WARM which only become visible when the temperature of the liquid within in within the range which activate the thermochromic ink.

In yet another embodiment of the invention, a single thermochromic segment, indicating hot, may be used, to indicate only that the coffee is either too hot to be comfortably consumed.

The material of the segments may also be plastic, or similar inexpensive thermochromic material.

The device is also useful for cups containing other liquids intended for human consumption, such as tea, soup, etc. It is further useful for indicating the temperature of other liquids, not intended for human consumption.

In other embodiments, the lid itself, or the cup itself may be made of a thermochromic material, which changes color continuously from blue to red, the exact shade corresponding to the temperature of the liquid.

In still other embodiments the temperature sensitive material may be used on containers intended to hold cold liquids.

In a final preferred embodiment the cup itself may have thermochromic segments attached, rather than placing them on the lid, or may be printed with thermochromic ink, in the same manner as used with the lids.

While the invention has been described with reference to specific embodiments, it will be apparent that improvements and modifications may be made within the purview of the invention without departing from the scope of the invention defined in the appended claims.

1. A cup intended for containing liquids, comprising a lid having a temperature indicating device attached to said lid.

2. The cup of claim 1, wherein the temperature-indicating device further comprises thermochromic ink.

3. The cup of claim 2, wherein the temperature indicating device further comprises one or more segments, each of which becomes visible within a different temperature range.

4. The cup of claim 2, wherein the temperature indicating device further comprises one or more segments, each of which changes color within a different temperature range.

5. A cup intended for containing liquids, comprising a temperature-indicating device attached thereto.

6. The cup of claim 5, wherein the temperature-indicating device further comprises thermochromic ink.

7. The cup of claim 6, wherein the temperature indicating device further comprises one or more segments, each of which becomes visible within a different temperature range.

8. The cup of claim 6, wherein the temperature indicating device further comprises one or more segments, each of which changes color within a different temperature range.

9. A cup lid intended to be affixed to a cup for containing liquids, comprising a temperature-indicating device attached thereto.

10. The cup lid of claim 9, wherein the temperature-indicating device further comprises thermochromic ink.

11. The cup lid of claim 10, wherein the temperature indicating device further comprises one or more segments, each of which becomes visible within a different temperature range.

12. The cup lid of claim 10, wherein the temperature indicating device further comprises one or more segments, each of which changes color within a different temperature range.

13. A method for indicating the temperature of liquids within a cup comprising a lid, the method comprising attaching a temperature-indicating device to the lid.

14. The method of claim 13, wherein the temperature-indicating device further comprises thermochromic ink.

15. The method of claim 14, wherein the temperature indicating device further comprises one or more segments, each of which becomes visible within a different temperature range.

16. The method of claim 14, wherein the temperature indicating device further comprises one or more segments, each of which changes color within a different temperature range.

17. A method for indicating the temperature of liquids within a cup, the method comprising attaching a temperature-indicating device to said cup.

18. The method of claim 17, wherein the temperature-indicating device further comprises thermochromic ink.

19. The method of claim 18, wherein the temperature indicating device further comprises tone or more segments, each of which becomes visible within a different temperature range.

20. The method of claim 18, wherein the temperature indicating device further comprises one or more segments, each of which changes color within a different temperature range.
